(19) United States
(12) Patent Application Publication
(10) Pub. No.: US 2002/0044551 A1
(43) Pub. Date: Apr. 18, 2002

(54) Method and apparatus for transferring data between units

(76) Inventor: Eiji Shimose, Kawasaki (JP)

Correspondence Address: ROSENMAN & COLIN LLP, 575 MADISON AVENUE, NEW YORK, NY, 10022-2585, US

(21) Appl. No.: 09/817,068

(22) Filed: Mar. 26, 2001

(30) Foreign Application Priority Data
Oct. 18, 2000 (JP) 2000-318402

(51) Int. Cl. H04L 12/56

(52) U.S. Cl. 370/389; 370/471; 370/535

(57) ABSTRACT

A main unit inserts first message-oriented data having a fixed data length to an overhead of a first main signal, and transfers the first main signal to a plurality of slave units. Each of the plurality of slave units receives the first main signal from the main unit, and separates the first message-oriented data inserted to the overhead of the first main signal. Additionally, each of the plurality of slave units inserts second message-oriented data having a fixed data length to an overhead of a second main signal, and transfers the second main signal to the main unit. The main unit receives the second main signal from the plurality of slave units, and separates the second message-oriented data inserted to the overhead of the second main signal. As described above, one-to-n or n-to-one data transmission is performed using message-oriented transmission data having a fixed data length, according to the present invention. Thus, the sizes of software and hardware included in each slave unit are comparatively small.

### BACKGROUND OF THE INVENTION

1. Field of the Invention

The present invention relates to a method and an apparatus for transferring data between units. More particularly, the present invention relates to a method and an apparatus for transferring data between a master unit and a plurality of slave units so that sizes of software and hardware implemented at the plurality of slave units can be decreased.

2. Description of the Related Art

In a subscriber transmission apparatus, data including control information and management information are typically transferred among a plurality of units by using an empty area of the main signal. In this case, one-to-n (1:n) data transmission is carried out from a single master unit to a plurality of salve units, and n-to-one (n:1) data transmission is carried out from the plurality of slave units to the single master unit. In such one-to-n and n-to-one data transmission methods, bit-oriented data having a fixed bit length with each bit having its specific meaning is used for data transfer for the purpose of decreasing the size of software and hardware that need to be developed. For instance, data having a m-bit data length is used as transferred data where a first bit of the data indicates the condition of a first circuit, with a value “0” indicating a normal condition and a value “1” indicating an abnormal condition. Similarly, a second bit through an m'th bit indicate the conditions of a second circuit through an m'th circuit, respectively.

Expansion of functions of the subscriber transmission apparatus is generally achieved by exchanging units provided therein. However, use of the bit-oriented transfer data imposes many restrictions on downward compatibility with conventional units because of inability to modify the bit length of transfer data, for example, and thus lacks sufficient expandability. In order to improve the expandability of the subscriber transmission apparatus, message-oriented data should be used for data transfer. For example, a packet including a message indicating whether the condition of a specific circuit is normal or abnormal is used for data transfer.

However, use of a general packet transmission method such as an LAPD (Link Access Procedure on the D-channel) for transmitting the message-oriented data creates a message having a variable bit length not only for the single master unit but also for the plurality of slave units. further, each slave unit needs to include software and hardware such as a CPU (Central Processing Unit) for decoding the message, and, thus, the size of software and hardware is bound to increase in each slave unit, resulting in a cost increase.

### SUMMARY OF THE INVENTION

Accordingly, it is a general object of the present invention to provide a method and an apparatus for transferring data between units. A more particular object of the present invention is to provide a method and an apparatus for transferring data between a main unit and a plurality of slave units wherein the size of software and hardware used in each slave unit can be decreased.

The above-described object of the present invention is achieved by a method of transferring message-oriented data between a main unit and a plurality of slave units, including the steps of inserting first message-oriented data having a fixed data length to an overhead of a first main signal at the main unit, transferring the first main signal from the main unit to the plurality of slave units, separating the first message-oriented data inserted to the overhead of the first main signal at the plurality of slave units, inserting second messageoriented data having a fixed data length to the overhead of a second main signal at the plurality of slave units, transferring the second main signal from the plurality of slave units to the main unit, and separating the second message-oriented data inserted to the overhead of the second main signal at the main unit.

As described above, one-to-n or n-to-one data transmission is performed using messageoriented transmission data having a fixed data length, according to the present invention. Thus, the size of software and hardware used in each slave unit decreases comparatively.

Other objects, features and advantages of the present invention will become more apparent from the following detailed description when read in conjunction with the accompanying drawings.

### BRIEF DESCRIPTION OF THE DRAWINGS

FIG. 1 is a block diagram showing a one-to-n data transmission portion of a data transmission apparatus, according to a first embodiment of the present invention;

FIG. 2 is a block diagram showing an n-to-one data transmission portion of the data transmission apparatus, according to a second embodiment of the present invention;

FIG. 3 is a diagram showing a multiframe format of a main signal;

FIGS. 4A, 4B and 4C are diagrams respectively showing structures of timeslots 25a, 26a and 27a included in a first frame of the main signal;

FIG. 5 is a diagram showing a multiframe format of an overhead of a multiframe transmitted from a main unit to a plurality of slave units, and multiframe formats of a short packet and a long packet transmitted from the plurality of slave units to the main unit;

FIGS. 6A and 6B are diagrams respectively showing a first byte of a 3-byte overhead included in each frame of signals transmitted through transmission paths, the first byte being expressed in a hexadecimal number, and a phase difference of the signals;

FIG. 7 is a diagram showing interruption detection timing at an interruption detection unit included in each of the plurality of slave units; and

FIGS. 8A and 8B are diagrams showing interruption detection timing at an interruption detection unit included in the main unit.

### DESCRIPTION OF THE PREFERRED EMBODIMENTS

A description will now be given of preferred embodiments of the present invention, with reference to the accompanying drawings.

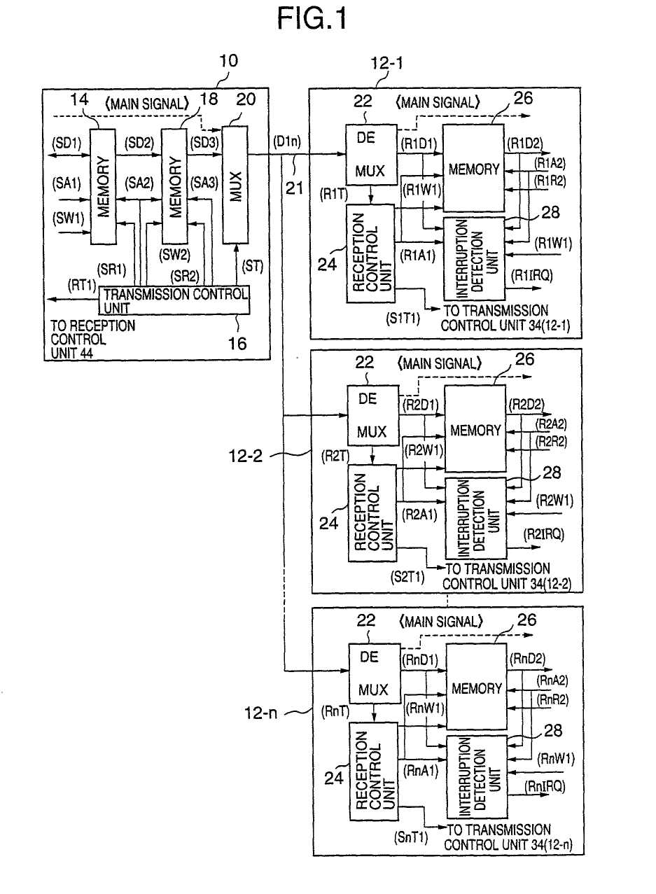

FIG. 1 is a block diagram showing a one-to-n data transmission portion of a data transmission apparatus, according to a first embodiment of the present invention. The one-to-n data transmission portion shown in FIG. 1 includes a main unit 10, a plurality of slave units 12-1 through 12-n and a transmission path 21. The main unit 10 is, for example, a TS (TimeSlot interchange) unit. The slave units 12-1 through 12-n are CH (CHannel card) units, for example. The value “n” is 240, for instance. The main unit 10 includes memories 14 and 18, a transmission control unit 16, and a multiplexer (MUX) 20. Each slave unit includes a de-multiplexer (DEMUX) 22, a reception control unit 24, a memory 26 and an interruption detection unit 28.

The memory 14 included in the main unit 10 is used for storing data to be transferred from the main unit 10 to the slave units 12-1 through 12-n. The main unit 10 initially supplies transmission data SD1 including interruption information such as an interruption flag whose value is “AAh” expressed in a hexadecimal number, to the memory 14. Additionally, the main unit 10 supplies a destination address SA1 corresponding to an address of a slave unit 12-i (i=1, 2, - - - , n), and a writing pulse SW1, to the memory 14, thereby writing the transmission data SD1 to the memory 14. Subsequently, the transmission data SD1 stored in the memory 14 is read as transmission data SD2 from the memory 14 by use of an address SA2 and a reading pulse SR1, both being supplied from the transmission control unit 16. The transmission data SD2 read from the memory 14 is, then, supplied to the memory 18, and is written to the memory 18 by use of the address SA2 and a writing pulse SW2 supplied from the transmission control unit 16. The memory 18 is a FIFO (First-In First-Out) unit that temporarily stores the transmission data SD2 until a fixed outputting timing comes so as to output the transmission data SD2 from the main unit 10. The transmission data SD2 stored in the memory 18 is read from the memory 18 as transmission data SD3 by use of an address SA3 and a reading pulse SR2 supplied from the transmission control unit 16, while a main signal is not outputted from the main unit 10. The transmission data SD3 read from the memory 18 is, then, supplied to the MUX 20. The MUX 20 executes time-division multiplexing of the transmission data SD3 to an overhead (an empty area) of the main signal on a data transmission side, and outputs the transmission data therefrom. In details, the MUX 20 multiplexes the transmission data SD3 read from the memory 18 to the overhead of the main signal, the overhead being located at a fixed position from a first transmission-side timing ST that is synchronous to the address (the address signal) SA3. Subsequently, the main unit 10 outputs the transmission data SD3 as transmission data D1n to the transmission path 21. The transmission control unit 16 generates the address SA2 supplied to the memories 14 and 18, the address SA3 supplied to the memory 18, the writing pulse SW2 supplied to the memory 18, the reading pulse SR1 supplied to the memory 14, the reading pulse SR2 supplied to the memory 18, the first transmission-side timing ST supplied to the MUX 20, and a standard receptionside timing RT1 supplied to a later-described reception control unit 44 included in the main unit 10. The first transmission-side timing ST is a master timing used for data transfer executed among the main unit 10 and the plurality of slave units 12-1 through 12-n.

The DEMUX 22 included in each slave unit 30 receives the transmission data D1n from the main unit 10 through the transmission path 21, and detects a first reception-side timing RiT (i=1, 2, - - - , n). Subsequently, the DEMUX 22 supplies the detected first reception-side timing RiT to the 35 reception control unit 24. Additionally, the DEMUX 22 separates a main signal for a slave unit including the DEMUX 22, from the transmission data D1n, and further separates data RiDl located at an overhead of the separated main signal. The DEMUX 22, then, supplies the data RiDl (overhead data) to the memory 26 and the interruption detection unit 28. The memory 26 stores the overhead data RiD1 by use of an address RiAl and a writing pulse RiW1 supplied from the reception control unit 24. The interruption detection unit 28 detects whether an interruption exists in the data RiD1, based on the address RiW1 supplied from the reception control unit 24 and the data RiD1. If the interruption is detected, the interruption detection unit 28 supplies a notification signal (interruption information) RiIRQ to a control unit not shown in the figures. After receiving the notification signal RiIRQ from the interruption detection unit 28, the control unit supplies an address RiA2 and a reading pulse RiR2 to the memory 26, thereby directing the slave unit 12-i to read the data RiD1 as data RiD2 from the memory 26. The interruption is canceled if the control unit accesses the address RiAl corresponding to cancellation of the interruption by use of the writing pulse RiW1. The reception control unit 24 generates the address RiAl supplied to the memory 26 and to the interruption detection unit 28, the writing pulse RiW1 supplied to the memory 26, and a standard transmission-side timing SiT1 supplied to a later-described transmission control unit 34 included in the slave unit 12-i.

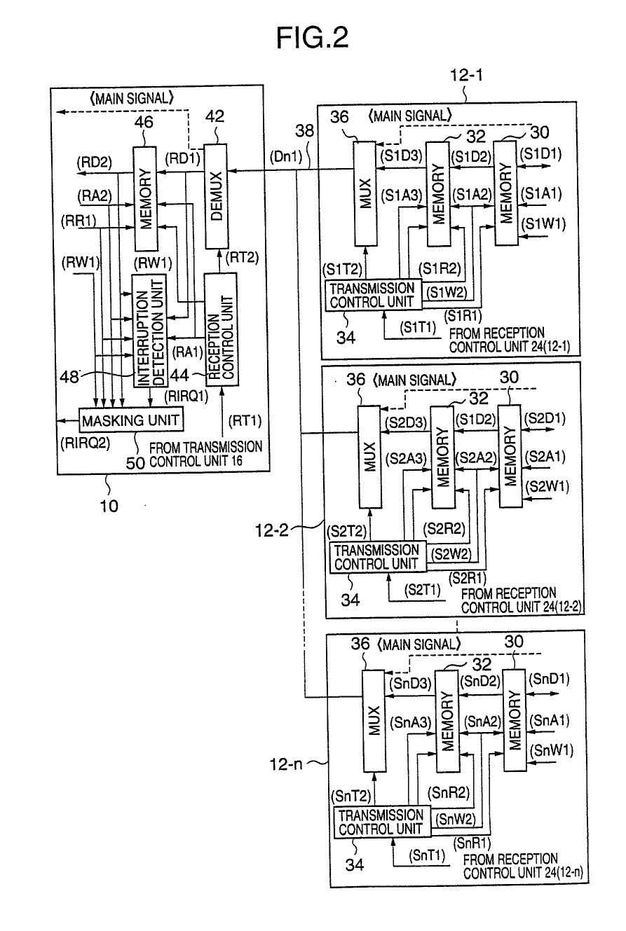

FIG. 2 is a block diagram showing an n-to-one data transmission portion of the data transmission apparatus, according to a second embodiment of the present invention. The n-to-one data transmission portion shown in FIG. 2 includes the main unit 10, the plurality of slave units 12-1 through 12-n and a transmission path 38. The main unit 10 includes a DEMUX 42, the reception control unit 44, a memory 46, an interruption detection unit 48 and a masking unit 50. Each of the plurality of slave units 12-1 through 12-n includes memories 30 and 32, the transmission control unit 34, and a MUX 36.

The memory 30 included in each of the plurality of slave units 12-1 through 12-n is used for storing (writing) transmission data to be transferred from a slave unit 12-i (i=1, 2, , n). The slave unit 12-i supplies transmission data SiD1 including interruption information (an interruption flag) from a data bus to the memory 30. Additionally the slave unit 12-i supplies an address SiAl corresponding to an address of the main unit 10, and a writing pulse SiWl, to the memory 30, thereby writing the transmission data SiD1 to the memory 30. The transmission data SiD1 stored in the memory 30 is read as transmission data SiD2 from the memory 30 by use of an address SiA2 and a reading pulse SiR1 supplied from the transmission control unit 34. Subsequently, the transmission data SiD2 read from the memory 30 is supplied to the memory 32, and is written to the memory 32 by use of the address SiA2 and a writing pulse SiW2 supplied from the transmission control unit 34. The memory 32 is an FIFO unit that temporarily stores the transmission data SiD2 until a fixed outputting timing comes so as to output the transmission data SiD2 from the slave unit 12-i. The transmission data SiD2 stored in the memory 32 is read as transmission data SiD3 from the memory 32 by use of an address SiA3 and a reading pulse SiR2 supplied from the transmission control unit 34, while a main signal is not outputted from the slave unit 12-i. The MUX 36 executes time-division multiplexing of the transmission data SiD3 to an overhead (an empty area) of the main signal on a transmission side, and outputs the transmission data SiD3 therefrom. In details, the MUX 32 multiplexes the transmission data SiD3 to the overhead of the main signal located at a fixed position from a first transmission-side timing SiT2 synchronous to the address (address signal) SiA3. The MUX 32, then, outputs the transmission data SiD3 as transmission data Di1 to the transmission path 38. The transmission control unit 34 generates the address SiA2 supplied to memories 30 and 32, the address SiA3 supplied to the memory 32, the writing pulse SiW2 supplied to the memory 32, the reading pulse Si1 supplied to the memory 30, the reading pulse SiR2 supplied to the memory 32, and the first transmission-side timing SiT2 supplied to the MUX 36. The DEMUX 42 of the main unit 10 receives the transmission data Di1 transmitted through the transmission path 38 from the slave unit 12-i, and separates a main signal and data (overhead data) located at an overhead position of the main signal, from the transmission data Di1. In details, the DEMUX 42 receives the transmission data Di1 from the slave unit 12-i, and separates the main signal and the overhead data as data RD1 from the transmission data Di1 by using a first reception-side timing RT2 supplied from the reception control unit 44. Subsequently, the DEMUX 42 supplies the data RD1 to the memory 46 and the interruption detection unit 48. The data RD1 is written to the memory 46 by use of an address RA1 and a writing pulse RWi supplied from the reception control unit 44. The data RD1 stored in the memory 46 is then read as data RD2 from the memory 46 by use of an address RA2 and a reading pulse RR1, both being supplied from a control unit not shown in the figures. The interruption detection unit 48 detects an interruption from an interruption flag included in overhead data for each transmission data received from the slave units 12-1 through 12-n. If the interruption is detected, the interruption detection unit 48 notifies about the interruption (RIRQ). In details, the interruption detection unit 48 detects an interruption in the received data RD1, based on the address supplied from the reception control unit 44 and the received data RD1. If the interruption is detected in the received data RD1, the interruption detection unit 48 supplies a notification signal (interruption information) RIRQ1 to the masking unit 50. The masking unit 50 masks the interruption information for each data received from the slave units 12-1 through 12-n. If a setting that is specified by the address RA2 and the data RD2, and that is written in advance by the writing pulse RW1 to the masking unit 50 specifies masking of a slave unit 12-i, the masking unit 50 masks the interruption information RIRQl supplied from the interruption detection unit 48 whether the interruption occurs or not, for making the interruption of the slave unit 12-i invalid. Interruption information RIRQ1 not masked by the masking unit 50 is supplied as an interruption notification RIRQ2 to the control unit. The control unit 10 reads the data RD2 from the memory 46 by use of the address RA2 and the reading pulse RR1 when receiving the interruption notification RIRQ2. After the data RD2 has been read from the memory 46, the interruption detection unit 48 and the masking unit 50 cancel the interruption notification RIRQ2 by a writing access to the address (an interruption cancellation address) RA2. The reception control unit 44 generates the address RA1 supplied to the memory 46 and to the interruption detection unit 48, the writing pulse RW1 supplied to the memory 46, and the first reception-side timing RT2 supplied to the DEMUX 42, by using the standard reception-side timing RT1 supplied from the transmission control unit 16.

A description will now be given of signals transmitted through the transmission paths 21 and 38, according to a third embodiment of the present invention. In the case of transmitting transmission data including setting information, requests, and the like, from the main unit 10 to each of the plurality of slave units 12-1 through 12-n, each packet of the transmission data has a fixed 24-byte data length including 23-byte data and an interruption flag, which is the last byte of the packet. A value “AAh” of the interruption flag indicates that an interruption exists in the packet. Other values of the interruption flag indicate that no interruption exists in the packet. On the other hand, in the case of transmitting transmission data including read-back information and performance information such as an error rate and an alarm, from each of the plurality of slave units 12-1 through 12-n to the main unit 10, the transmission data can be transmitted in a short packet or a long packet. The short packet has a 96-byte data length including 95-byte data and an interruption flag, which is the last byte of the short packet. In a case of transmitting the transmission data in the short packet, a value “AAh” of the interruption flag indicates that an interruption exists in the short packet. Other values of the interruption flag indicate that no interruption exists in the short packet. The long packet has a 96-byte data length including 8 groups of 95-byte data and 1-byte idle information, 95-byte data, an interruption flag, that is, the last byte of the long packet, and 96-byte idle information. In a case of transmitting the transmission data in the long packet, a value “99h” of the interruption flag indicates that an interruption exists in the long packet. Other values of the interruption flag indicate that no interruption exists in the long packet.

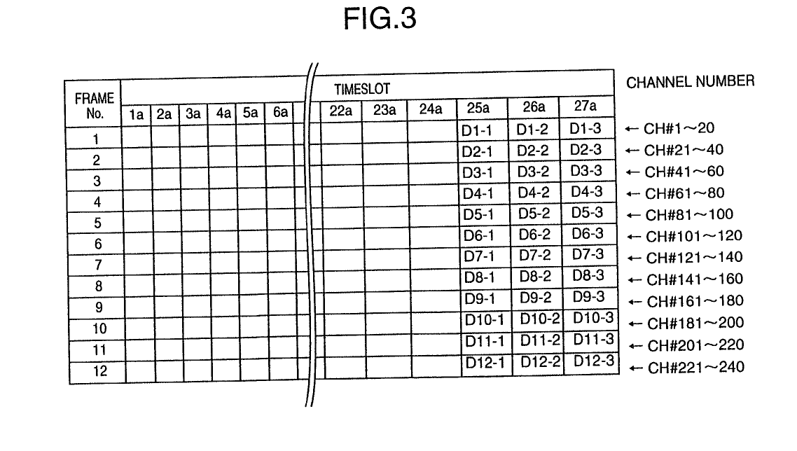

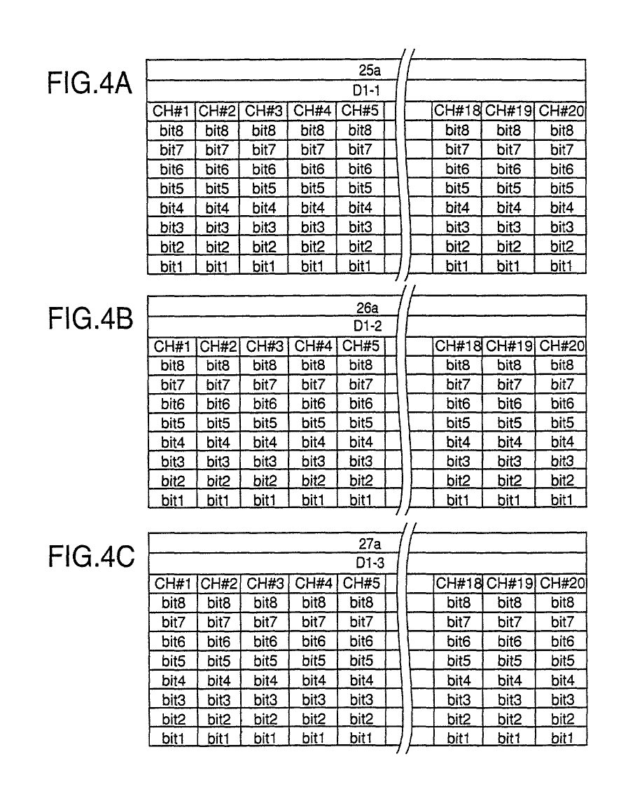

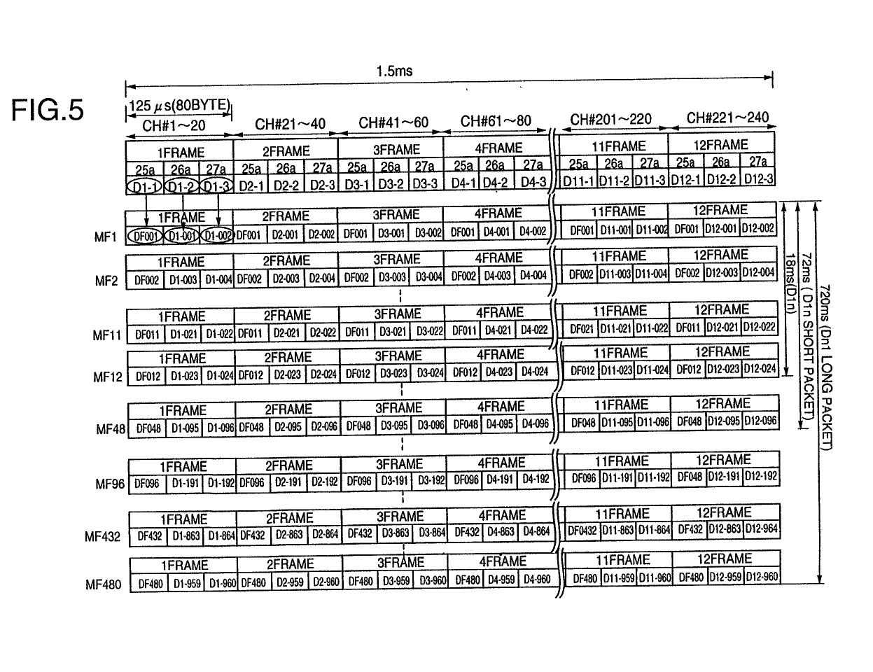

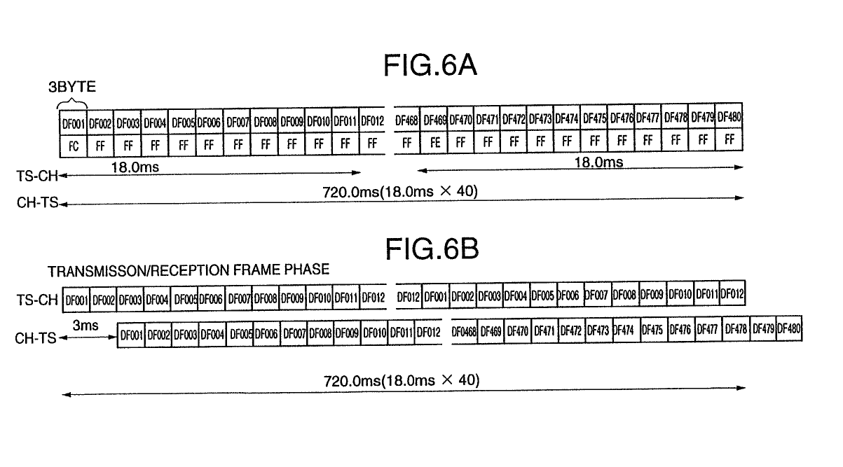

FIG. 3 is a diagram showing a multiframe format of a main signal. The main signal includes five shelves, whereas FIG. 3 shows one of the five shelves. In FIG. 3, timeslots la through 24a of each frame are a main signal area. Timeslots 25a through 27a are an overhead (an empty area), in which transmission data is multiplexed. The timeslots 25a through 27a of 12 frames are assigned to destination channels 1 through 240 (CH#1-CH#240) corresponding to the slave units 12-1 through 12-240, as shown in FIG. 3. FIGS. 4A, 4B and 4C are diagrams respectively showing structures of the timeslots 25a, 26a and 27a of a first frame. The timeslots 1a through 24a of the first frame are assigned to the destination channels 1 through 20 (CH#1-CH#20). Additionally, FIG. 5 is a diagram showing a multiframe format of an overhead of a multiframe transmitted from the main unit 10 to the slave units 12-1 through 12-n, and of a short packet and a long packet transmitted from the slave unit 12-1 through 12-n to the main unit 10. Furthermore, FIG. 6A is a diagram showing a first byte of a 3-byte overhead included in each frame of signals transmitted through the transmission paths 21 and 38, the first byte being expressed in a hexadecimal number. Additionally, FIG. 6B is a diagram showing a phase difference of the signals.

The first transmission-side timing ST used or transmitting transmission data from the main unit 10 to the plurality of slave units 12-1 through 12-n is a signal having a 1.5 ms cycle. The first byte of the 3-byte overhead of each frame is set to a value “FFh” or “FEh” to indicate the first transmissionside timing ST. 24-byte transmission data is transmitted in a 18 ms cycle for transmitting multi frames (12 frames), each frame including 2-byte data of the 3-byte overhead except the first byte. Accordingly, the first byte of an overhead indicating a beginning of the 18ms cycle has a value “FEh”, as shown in FIG. 6A. In a case in which transmission data is transmitted from the slave units 12-1 through 12-n to the main unit 10 by use of the long packet, each long packet is transmitted by 960 bytes in a 720 ms cycle. Accordingly, the first byte of an overhead indicating a beginning of the 720 ms cycle has a value “FCh”, as shown in FIG. 6A. On the other hand, in a case in which the transmission data is transmitted from the slave units 12-1 through 12-n to the main unit 10 by use of the short packet, each short packet is transmitted by 96 bytes in a 72 ms cycle. The first byte of an overhead indicating a beginning of the 72 ms cycle has a value “FEh”.

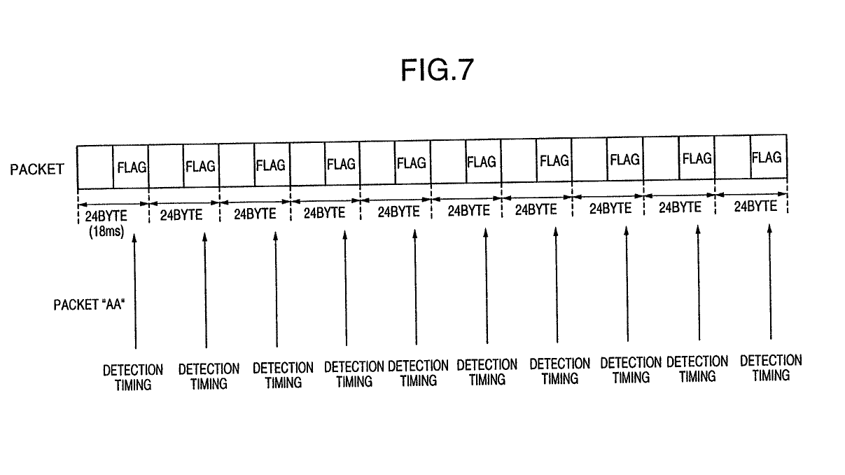

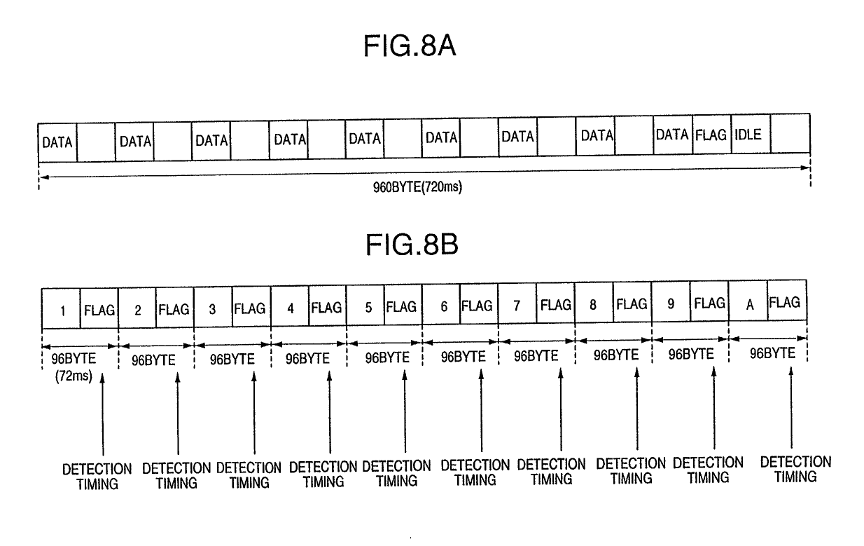

FIG. 7 is a diagram showing interruption detection timing at the interruption detection unit 28 included in each of the slave units 12-1 through 12-n. Since a packet of transmission data has a 24-byte data length including 23-byte data and an interruption flag, which is the last byte of the packet, the interruption detection unit 28 detects an interruption by determining whether a value of the interruption flag located at the last byte of an 18 ms cycle shown in FIG. 7 is “AAh” or not. FIGS. 8A and 8B are diagrams showing interruption detection timing at the interruption detection unit 48 included in the main unit 10. As described above, a long packet has a fixed 96-byte data length, including 8 groups of 95-byte data and a byte of idle information, 95-byte data, an interruption flag indicating an interruption as “99h”, and 96-byte idle information, as shown in FIG. 8A. A short packet has a fixed 96-byte data length, including 95-byte data and an interruption flag, which is the last byte of the short packet, as shown in FIG. 8B. Accordingly, the interruption detection unit 48 of the main unit 10 determines whether the last byte of a 72 ms cycle shown as an arrow in FIG. 8B is a value “AAh” or “99h”. If the interruption detection unit 48 determines that the last byte is the value “AAh”, a packet received from a slave unit is a short packet. If the interruption detection unit 48 determines that the last byte is the value “99h”, the packet received from a slave unit is a long packet.

As describe above, one-to-n or n-to-one data transmission is performed using message-oriented transmission data having a fixed data length, according to the present invention. Thus, the size of software and hardware included in each slave unit are comparatively small.

The above description is provided in order to enable any person skilled in the art to make and use the invention and sets forth the best mode contemplated by the inventors of carrying out the invention.

The present invention is not limited to the specially disclosed embodiments and variations, and modifications may be made without departing from the scope and spirit of the invention.

The present application is based on Japanese Priority Application No. 2000-318402, filed on Oct. 18, 2000, the entire contents of which are hereby incorporated by reference.

What is claimed is:

1. A method of transferring message-oriented data between a main unit and a plurality of slave units, comprising the steps of:
inserting first message-oriented data having a fixed data length to an overhead of a first main signal at said main unit;
transferring the first main signal from said main unit to said plurality of slave units;
separating said first message-oriented data inserted to the overhead of the first main signal at said plurality of slave units;
inserting second message-oriented data having a fixed data length to the overhead of a second main signal at said plurality of slave units;
transferring the second main signal from said plurality of slave units to said main unit; and
separating said second message-oriented data inserted to the overhead of the second main signal at said main unit.

2. The method as claimed in claim 1, wherein said second message-oriented data is one of a first packet having a first data length and a second packet having a second data length, which is a multiple of said first data length.

3. The method as claimed in claim 1, further comprising the steps of:
providing head data having a fixed value in said first and second message-oriented data inserted to the overhead of said first and second main signals, respectively; and
detecting said head data in said first and second message-oriented data separated respectively from said first and second main signals, thereby recognizing beginnings of said first and second message-oriented data.

4. A main unit transferring message-oriented data to a plurality of slave units, comprising:
a first memory storing the message-oriented data that has a fixed data length, and includes interruption information, at an address corresponding to each of the plurality of slave units;
a second memory storing the message-oriented data read from said first memory at the address corresponding to said each of the plurality of slave units, from which said message-oriented data is read out at timing corresponding to an overhead of a main signal; and
a multiplexer inserting said message-oriented data read out from said second memory to the overhead of the main signal, and transferring said main signal to said plurality of slave units.

5. A slave unit receiving message-oriented data transferred from a main unit to a plurality of slave units, comprising:
a de-multiplexer separating the message-oriented data inserted to an overhead of a main signal received from said main unit, said message-oriented data corresponding to said slave unit;
a memory storing said message-oriented data separated from the main signal; and
an interruption detection unit detecting whether an interruption exists in said message-oriented data, based on interruption information included in said message-oriented data.

6. A slave unit transferring message-oriented data from a plurality of slave units to a main unit, comprising:
a first memory storing the message-oriented data that has a fixed data length, and includes interruption information;
a second memory storing the message-oriented data read from said first memory, from which said message-oriented data is read out at timing corresponding to said slave unit in an overhead of a main signal; and
a multiplexer inserting said message-oriented data read out from said second memory to the overhead of the main signal, and transferring said main signal to said main unit.

7. The slave unit as claimed in claim 6, wherein said slave unit selects one of a first packet having a fixed first data length and a second packet having a second data length, which is a multiple of said first data length, for transferring said message-oriented data by use of a selected packet, and for determining a value of said interruption information in accordance with the selected packet.

8. A main unit receiving message-oriented data from a plurality of slave units, comprising:
a de-multiplexer separating the message-oriented data inserted to an overhead of a main signal that is received from each of said plurality of slave units;
a memory storing said message-oriented data separated from the main signal; and
an interruption detection unit detecting whether an interruption exists in said message-oriented data, based on interruption information included in said message-oriented data.

9. The main unit as claimed in claim 8, wherein said interruption detection unit detects whether said message-oriented data is a first packet having a first fixed data length or a second packet having a second data length, which is a multiple of said first data length, based on said interruption information.

10. The main unit as claimed in claim 8, wherein said interruption detection unit outputs a detection signal if the interruption exists in said message-oriented data, and said main unit further comprises a masking unit invalidating said detection signal by each slave unit.
